(19) United States
(12) Patent Application Publication
(10) Pub. No.: US 2012/0292263 A1
(43) Pub. Date: Nov. 22, 2012

(54) FLUID PURIFICATION SYSTEMS AND METHODS

(75) Inventor: Kenneth L. Geiger, Sebring, FL (US)

(73) Assignee: NEXT GENERATION FILTRATION SYSTEMS, LP, Pittsburgh, PA (US)

(21) Appl. No.: 13/108,316

(22) Filed: May 16, 2011

(51) Int. Cl. B01D 1/00; F28D 15/00

(52) U.S. Cl. 210/774; 165/104.11; 210/180

(57) ABSTRACT

Apparatuses and methods for warming a volatile containing fluid in a system using a heat transfer fluid and thereby removing volatiles from the fluid system. The apparatuses and methods include a heat transfer fluid vessel disposed in an evaporator chamber. The apparatuses and methods may furthermore include a volatile containing fluid inlet, a volatile containing fluid outlet, a volatile removal gas inlet and a volatile removal gas outlet disposed through the evaporator section.

### CROSS-REFERENCE TO RELATED APPLICATIONS

None.

### FIELD OF THE INVENTION

The present invention is directed to fluid filtration systems and methods. In particular, the fluid filtration systems and methods are directed to systems and methods that remove particulates and volatiles from oil, hydraulic fluid, petroleum products or other liquids from which volatiles are desired to be removed (hereinafter referred to as “oil”).

### BACKGROUND OF THE INVENTION

Oils and other fluids are used in various applications, including, for example, lubrication of machinery and to apply hydraulic force to various actuators. Such systems may be substantially closed, as in an engine lubrication application, or open, such as in a hydraulic system having a vented tank. In both those systems, the fluids may be replaced frequently. Such replacement may not be required because the fluid itself is ineffective, but rather because the fluid has become suffused with undesirable materials, such as particulates, water, or uncombusted fuel. Thus, it is believed that there is a need for filtration systems and methods that improve the cleanliness of such fluids to save the costs of labor and replacement fluids. It is furthermore believed that there is a need for filtration systems and methods that improve the cleanliness of such fluids to minimize wasting resources, such as oil and hydraulic fluid, which may continue to be effective once cleaned.

### SUMMARY OF THE INVENTION

The present invention is directed to systems, methods and apparatuses for removing volatiles from fluids by warming the volatile containing fluid using a heat transfer fluid vessel.

In accordance with one form of the present invention, there is provided a fluid purification apparatus having a particulate filter section, an evaporator section positioned adjacent the particulate filter section, and a heat transfer fluid vessel disposed at least partially in the evaporator section. The heater may include a bayonet tube and may have a surface with a ridge. An evaporation tube having a conically shaped outer surface that is placed around the heater is also provided in an embodiment.

In accordance with another form of the present invention, there is provided a method of removing volatiles from a fluid. That method includes heating a chamber using a hot fluid flowing through a channel disposed in the chamber, causing the oil to flow through the chamber, and causing a gas to flow through the chamber. In that method, the hot fluid flowing through the channel may warm the chamber, thereby causing volatiles in the oil to transition to a gaseous state and the gas flowing through the chamber may mix with the gaseous volatiles, thereby carrying the gaseous volatiles out of the chamber.

In accordance with yet another form of the present invention, there is provided an evaporation chamber formed in an enclosure with an evaporation tube extending at least partially into the enclosure, a heat transfer fluid inlet passing through the enclosure, a heat transfer fluid outlet passing through the enclosure, a heat transfer fluid passage passing from the heat transfer fluid inlet, through the evaporation tube, to the heat transfer fluid outlet, a volatile containing fluid inlet passing through the enclosure, a volatile containing fluid outlet passing through the enclosure, a volatile containing fluid passage passing from the volatile containing fluid inlet to the vicinity of the evaporation tube, a volatile removal inlet through the enclosure, and a volatile removal outlet through the enclosure. In operation, that embodiment may warm the evaporation tube with heat transfer fluid flowing into the evaporation chamber through the heat transfer fluid inlet, through the heat transfer fluid passage, and out of the evaporation chamber through the heat transfer fluid outlet; the volatile containing fluid may pass into the evaporation chamber through the volatile containing fluid inlet, be warmed in the evaporation chamber such that volatiles contained in the volatile containing fluid become gaseous, and then pass out of the evaporator chamber through the volatile containing fluid outlet; and the gaseous volatiles may be removed from the evaporation chamber by air or other gas flowing into the evaporator chamber through the volatile removal inlet, passing through the evaporation chamber, and exiting the evaporation chamber through the volatile removal outlet.

The present fluid purification apparatus provides advantages that may include improved fluid heating and volatile removal. The present fluid purification apparatus also provides improved safety for the fluid and the system served by the fluid.

Accordingly, the present invention provides solutions to the shortcomings of prior fluid filtration systems and methods. Those of ordinary skill in fluid purification and volatile removal will readily appreciate, therefore, that those details described above and other details, features, and advantages of the present invention will become further apparent in the following detailed description of the preferred embodiments of the invention.

### BRIEF DESCRIPTION OF THE DRAWINGS

The accompanying drawings, which are incorporated herein and constitute part of this specification, include one or more embodiments of the invention, and together with a general description given above and a detailed description given below, serve to disclose principles of the invention in accordance with a best mode contemplated for carrying out the invention.

FIG. 1 is a cross-sectional view of an embodiment of a fluid purification apparatus;

FIG. 2 is a side view of an embodiment of an evaporation chamber heater for an embodiment of a filtration device.

FIG. 3 is a cross-sectional view of an embodiment of an evaporation chamber in a filtration device that may be suitable for use with a small engine;

FIG. 4 is a cross-sectional view of an embodiment of an evaporation chamber in a filtration device that may be suitable for use with a hydraulic system;

FIG. 5 is an illustration of an embodiment of an engine incorporating a fluid purification apparatus;

FIG. 6 is an illustration of an embodiment of a hydraulic system incorporating a fluid purification apparatus; and

FIG. 7 is an illustration of an embodiment of a cap having airflow openings.

### DETAILED DESCRIPTION OF THE INVENTION

Reference will now be made in detail to the preferred embodiments of the present invention, examples of which are illustrated in the accompanying drawings. It is to be understood that the figures and descriptions of the present invention included herein illustrate and describe elements that are of particular relevance to the present invention, while eliminating, for purposes of clarity, other elements found in typical systems with which fluid purification apparatuses and methods are employed.

Any reference in the specification to “one embodiment” or “an embodiment” means that a particular feature, structure or characteristic described in connection with the embodiment is included in at least one embodiment of the invention. The appearances of phrases such as “in one embodiment” in various places in the specification are not necessarily all referring to the same embodiment. References to “or” are furthermore intended as inclusive so “or” may indicate one or another of the ored terms or more than one ored term.

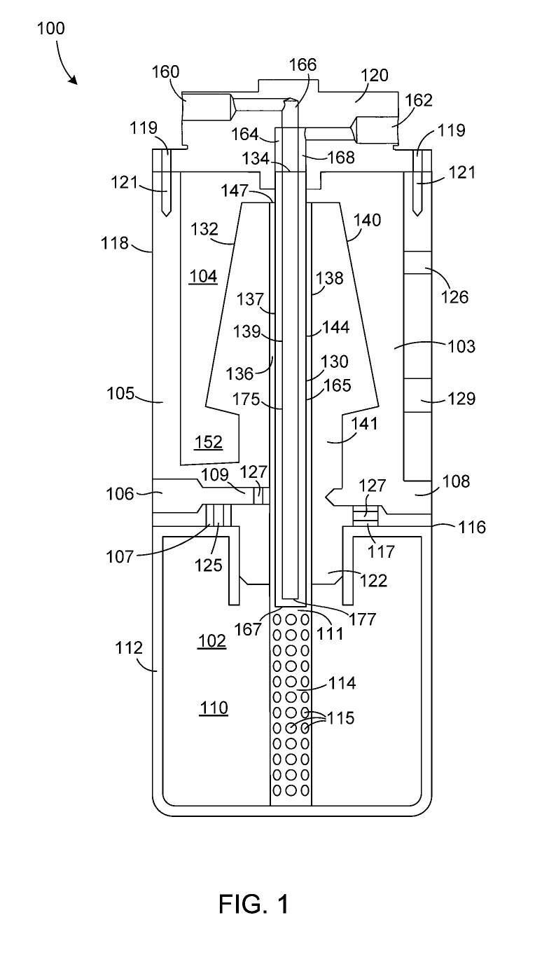

FIG. 1 illustrates a cross-sectional view of an embodiment of a fluid purification apparatus 100. Fluid purification apparatus 100 includes a filter chamber 102, an evaporator chamber 104, and a filter base 105, which may form part of an enclosure that encloses one or both of the chambers 102 and 104. The filter base 105 may be formed of aluminum or another desired material and may be formed by extrusion, machining, casting, or another desired method.

The fluid purification apparatus 100 may be used in various applications including filtration of lubricants in engines of various types and in pressurized fluid applications such as hydraulic fluid filtration. Oil, hydraulic fluid, or another fluid may pass through the filter chamber 102 and the evaporator chamber 104 in series and in either order or may pass through the filter chamber 102 or the evaporator chamber 104 individually or in parallel.

The fluid purification apparatus 100 of FIG. 1 includes an inlet 106 having a filter inlet 107 and an evaporator inlet 109, an outlet 108 having a filter outlet 117, and an inner-chamber opening 111. The filter chamber 102 furthermore includes a filter cavity 110, and a filter canister 112. A threaded circular portion 122 may also extend from the divider 116 opposite a circular wall 118 for attachment of the filter canister 112. The threaded circular portion 122 may form part of an enclosure that encloses the filter chamber 102 and the circular wall 118 may form part of an enclosure that encloses the evaporator chamber 104.

The filter canister 112 may be configured for ease of removal from the fluid purification apparatus 100 to facilitate changing filter media. For example, in one embodiment, the filter media is permanently sited in a replaceable, disposable filter canister 112 and the filter canister 112 is screwed to the filter base 105 similar to a cap on a conventional oil filter.

In the embodiment illustrated in FIG. 1, the inner-chamber opening 111 is coupled to a perforated tube 114 that passes through a central cylindrical opening in the filter media. In that embodiment, the filtered fluid may flow into the perforated tube 114 through the perforations 115 and enter the evaporation chamber 104 through the inner-chamber opening 111. That inner-chamber opening 111 may be aligned with a fluid heating channel 143 in the evaporation chamber 104 so that flow from the filter chamber 102 into the evaporator chamber 104 is directed through the heated space 136 formed between an inner surface 138 of an evaporation tube 132 and a heater 130 described hereinafter.

The filter media may be any type of filter media desired including, for example, paper filters, fiberglass filters, and filters made of various materials that are now or may in the future be available. The filter media may be shaped as a cylinder having a hole in the center through which the perforated tube 114 may be positioned. The filter media may furthermore be pleated to provide a high surface area on which to capture particulates and may be removable and replaceable.

The filter base 105 illustrated in FIG. 1 includes a divider 116 that at least partially separates the filter chamber 102 from the evaporation chamber 104. The filter base 105 may also include a circular wall 118 that extends from the divider 116 to at least partially enclose the evaporation chamber 104. An evaporation chamber cap 120 may be attached to the filter base 105 to cover and provide access to the evaporation chamber 104. The evaporation chamber cap 120 may be attached to the filter base 105 as desired and may, for example, be attached by way of screws extending through holes 119 in the cap 120 and threaded into threaded holes 121 formed in the circular wall 118.

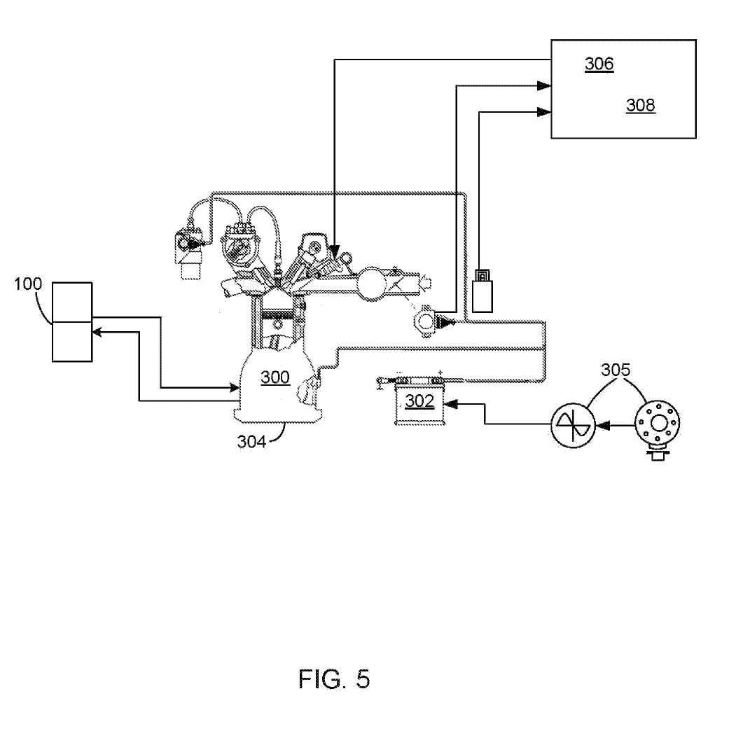

In an embodiment, the heater 130 is a fluid vessel 165 having a supply conduit 131 and a return conduit 133 that pass from the fluid vessel 165 to a heat transfer fluid source through a heater opening 134 in the fluid purification apparatus 100 to a hot fluid source. In automotive applications, for example, that heat transfer fluid source may be the cooling system of an engine, such as the engine 300 illustrated in FIG. 5. That cooling system may, for example conduct fluid, such as water or glycol, through the engine to draw heat from the engine into the fluid flowing through the cooling system and expel that heat into the atmosphere. Alternately, another source of heat transfer fluid may supply heat transfer fluid to the fluid vessel 165.

The fluid vessel 165 may be a bayonet tube comprising two coaxial heat transfer fluid tubes 137 and 139. The outer heat transfer fluid tube 137 has a closed end and the heat transfer fluid flows through the inner heat transfer fluid tube 139 until it reaches the end of the bayonet tube where it impinges against the closed end of the outer heat transfer fluid tube 137 to reverse its direction and flow back in an annular space between the outer heat transfer fluid tube 137 and inner heat transfer fluid tube 139, exiting the heater through the return conduit 133.

In an embodiment, heat is provided to the evaporator chamber 104 by circulating the heat transfer fluid through the evaporator tube 132. In such an embodiment, the evaporator chamber 104 cap 120 may include a heat transfer fluid inlet 160 and a heat transfer fluid outlet 162. The heat transfer fluid inlet 160 and heat transfer fluid outlet 162 may be coupled to an external heat transfer fluid source, such as a water and glycol mixture used as an engine coolant. The heat transfer fluid inlet 160 and heat transfer fluid outlet 162 may be in fluid communication with a heat transfer fluid tube engaging bore 164 that includes a small diameter bore 166 extending from a large diameter bore 168. The heat transfer fluid inlet 160 may be in direct fluid communication with the small diameter bore 166 and the heat transfer fluid outlet 162 may be in direct fluid communication with the large diameter bore 168 or the heat transfer fluid outlet 162 may be in direct fluid communication with the small diameter bore 166 and the heat transfer fluid inlet 160 may be in direct fluid communication with the large diameter bore 168, as desired.

The evaporation tube 132 may be of any desired shape, including the conical shape illustrated in FIG. 1, a block, a sphere or other shape desired. The evaporation tube 132 may also include fluid passages of any size and shape, including the straight through fluid heating channel 136 illustrated in FIG. 1, a curved or serpentine passage, or a passage leading to a chamber (not shown), which may include another passage leading out of the evaporation chamber 132 from the chamber.

Internally, the heat transfer fluid may flow from the heat transfer fluid inlet 160, through the evaporation tube 132, and out through the heat transfer fluid outlet 162. In one such embodiment, which is illustrated in FIG. 1, an outer heat transfer fluid tube 137 is fitted into the large diameter bore 168 of the heat transfer fluid tube engaging bore 164, the outer heat transfer fluid tube 137 extending into the fluid heating channel 139, and an inner heat transfer fluid tube 139 is fitted into the small diameter bore 166 of the heat transfer fluid tube engaging bore 164, extending into the outer heat transfer fluid tube 137. In that way, heated liquid flowing through the heat transfer fluid inlet 160 may be directed into the inner heat transfer fluid tube 139 through the small diameter bore 166, flow from the inner heat transfer fluid tube 139 into a space between the inner heat transfer fluid tube 139 and the outer heat transfer fluid tube 137, and then pass out through the large diameter bore 168 and the heat transfer fluid outlet 162. Alternately, heated liquid flowing through the heat transfer fluid inlet 160 may be directed through the large diameter bore 168 into the space between the inner heat transfer fluid tube 139 and the outer heat transfer fluid tube 137, flow from that space into the inner heat transfer fluid tube 139, and then pass out through the small diameter bore 166 and the heat transfer fluid outlet 162.

In one embodiment, the heat transfer fluid inlet 160, the heat transfer fluid outlet 162, and the heat transfer fluid tube engaging bore 164 are incorporated into the evaporator cap 120. In that embodiment, the outer heat transfer fluid tube 137 and inner heat transfer fluid tube 139 may be fitted to the heat transfer fluid tube engaging bore 164 of the evaporator chamber 104 cap 120 in such a way as to permit the heat transfer fluid to pass from the heat transfer fluid inlet 160 through the outer heat transfer fluid tube 137 and inner heat transfer fluid tube 139 and then out through the heated fluid outlet 162. For example, as shown in FIG. 1, the inner heat transfer fluid tube 139 is fitted by threads, interference fit, welding, or otherwise as desired, into the small diameter bore 166 of the heat transfer fluid tube engaging bore 164 and the outer heat transfer fluid tube 137 is similarly fitted into the large diameter bore 168 of the heat transfer fluid tube engaging bore 164. In that embodiment, the cap 120 complete with a heat transfer fluid assembly 168 may be fitted onto the evaporation chamber 104 as a unit with the heat transfer fluid assembly 168 extending into the evaporator tube 132.

In one embodiment, the outer heating fluid tube 137 diameter and the inner heating fluid tube diameter 139 are chosen to have a first axial volume between an outer surface 175 of the inner heating fluid tube 139 and an inner surface 169 of the outer heating fluid tube 137 and a second axial volume inside the inner heating fluid tube 139, wherein the first axial volume and the second axial volume are approximately the same.

An end 177 of the inner heating fluid tube 139 may extend to an end 167 of the outer fluid heating tube 137 and have one or more holes near the end of the inner heating fluid tube 139 through which the heating fluid may flow. Alternately, the inner heating fluid tube 139 may not extend to the end 167 of the outer fluid heating tube 137 so that heating fluid can flow into or out of the end of the inner heating fluid tube 139. Moreover, the inner heating tube 139 may have one or more outward radiating braces that contact or come into close proximity with the outer heating fluid tube 137 to hold the inner heating fluid tube 139 in a desired position within the outer heating fluid tube 137.

In another embodiment, the outer heating tube may be omitted and the heat transfer fluid may pass from the heat transfer fluid inlet 160 through the large diameter bore 168, which is sealed from the evaporation tube 132. The large diameter bore 168 may be constructed of a material such as aluminum. The heat transfer fluid may then pass between the evaporation tube 132 and the inner heat transfer fluid tube 139 along much or all of the length of the evaporation tube 132, thereby heating the evaporation tube 132 to promote evaporation of the volatiles in the evaporation chamber 104. The evaporation tube 132 may be constructed of a material such as brass. The inner heat transfer fluid tube 139 may extend most or all of the length of the evaporation tube 132 and be arranged with one or more holes near the end of the evaporation tube 132 or otherwise arranged such that the heat transfer fluid flows into the inner heat transfer fluid tube 139 near a closed end (not shown) of the evaporation tube 132 and exits the evaporation chamber 104 through the inner heat transfer fluid tube 139, the small diameter bore 166 and the water outlet. It should be recognized that flow could be reversed in such an embodiment. Furthermore, in such an embodiment, the oil or filtered fluid from which volatiles are to be removed may not enter the evaporation chamber 104 through the center of the evaporation tube 132, but may rather be otherwise deposited on the exterior surface 140 of the evaporation tube 132.

In yet another embodiment, the heat transfer fluid may pass through one or more passages (not shown) in the evaporation tube 132 in such a way as to be kept separate from the oil or other fluid from which the volatiles are being removed, thereby preventing the heat transfer fluid from mixing with the fluid from which the volatiles are being removed. Thus, the heat transfer fluid may pass through, near, or adjacent to the evaporation tube 132 to heat the evaporation tube 132 and the oil or other fluid from which volatiles are to be removed may separately pass through, near, or adjacent the evaporation tube 132 such that the oil or other fluid from which the volatiles are to be removed is warmed by heat transferred from the heat transfer fluid through the evaporation tube 132 to the oil or other fluid from which volatiles are to be removed.

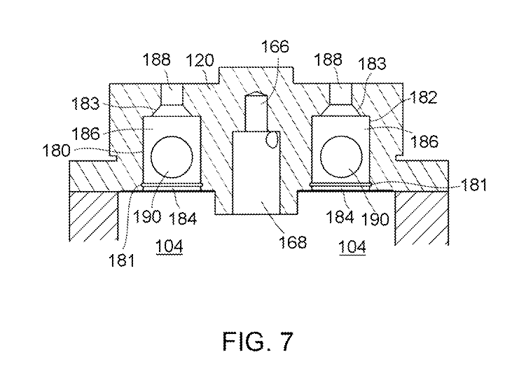

FIG. 7 illustrates an embodiment of a cap 120. The cap 120 illustrated in FIG. 7 includes one or more openings for airflow to remove volatiles from the evaporation chamber 104. In the embodiment illustrated in FIG. 7, the cap 120 includes a volatile removal inlet port, which may be an air inlet port 180 in certain embodiments and a volatile removal outlet port, which may be an air outlet port 182 in certain embodiments. To enhance removal of airborne volatiles, an air flow stream may be created through the evaporator chamber 104 through the evaporator gas inlet 129 and the evaporator gas outlet 126. In embodiments, the volatile removal inlet port, also referred to as an air inlet port 180 may be in fluid communication with a clean air source, such as an air cleaner of an internal combustion engine, or with a pressurized air source such as a turbocharger or an engine crankcase. The volatile removal outlet port, also referred to as an air outlet port 182 may be in fluid communication with the air cleaner or a vacuum source, such as an intake manifold in an internal combustion engine. Fluid communication between the air inlet port 180 and its source, and between the air outlet port 182 and the place where it discharges air, may be facilitated by connecting tubing between each of those ports 180 and 182 and their source and discharge locations, respectively.

One or both of the air inlet 180 and the air outlet 182 may be fitted with a valve to prevent filtered fluid from escaping from the evaporation chamber 104. For example, in the embodiment illustrated in FIG. 7, a chamber access hole 184 extends into the evaporation chamber 104 and an atmospheric hole 188 extends through the side of the cap 120 opposite the evaporation chamber 104, with a valve opening 186 located between the holes 184 and 188 for each of the air inlet 180 and air outlet 182. In the embodiment illustrated in FIG. 7, balls 190 are fitted into each of the valve openings 186 and a ridge 181 is included in each of the chamber access holes 184. A retention clip (not shown) may be fitted into each ridge 181 to prevent the ball 190 located in one or both of the air inlet 180 and the air outlet 182 valve openings 186 from moving into the evaporation chamber 104. A seat 183 is formed between the atmospheric hole 188 and the valve opening 186 in each of the air inlet 180 and air outlet 182 in the embodiment illustrated in FIG. 7. The seats 183 are included such that the balls 190 seal against the seats 183 when they rise in the valve openings 186 due to oil infiltrating the valve opening. The retention clip may, for example, include a wire bent into a square shape with the corners of the wire square fitted into one of the ridges 181. The ball 190 fitted into each valve opening 186 may have a specific gravity such that it will float on the oil, thereby rising to seal against the seat if the oil fills the evaporation chamber 104 and flows into the chamber access holes 184 of either the air inlet 180 or air outlet 182. Accordingly, the ball 190 in the breached inlet 180 or outlet 182 will float up to block one of the atmospheric holes 188 and seal against the seat 183 formed between each atmospheric hole 188 and valve opening 186 to prevent the oil from escaping from the evaporation chamber 104 through the air inlet 180 or air outlet 182.

The evaporation chamber cap 120 may be formed of aluminum, plastic, or another material depending on the requirements of the application.

In the embodiment illustrated in FIG. 1, the evaporation tube 132 is fitted around the heater 130 and fluid passes from the filter chamber 102 into the evaporator chamber 104 through a heated space 136 formed between the heater 130 and an inner surface 138 of the evaporation tube 132. The heated fluid then passes over an outer surface 140 of the evaporation tube 132 and volatiles, such as water and uncombusted fuel, may become gaseous and those gases may be vented from the evaporator chamber 104 through the air outlet 182.

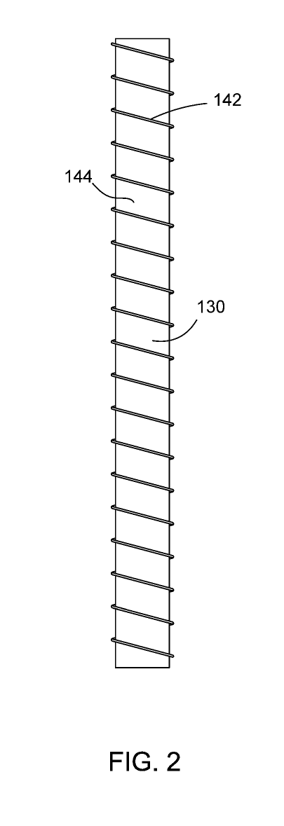

FIG. 2 illustrates an embodiment of the heater 130 having a surface 144 and a wire 142 wound helically along the surface 144 of the heater 130. A ridge or groove may be formed on the surface 144 of the heater 130 or the inner surface 138 of the evaporation tube 132 rather, or in addition to using the wire 142 winding. Alternately, other shapes may be formed on the heater 130 or evaporator tube 132, or other apparatuses may be placed between the heater 130 and the inner surface 138 of the evaporation tube 132 in any desired way to increase the duration the fluid remains proximate to or near the heater to improve fluid heating. For example, the inner surface 138 of the evaporation tube 132 may include a helical groove or other surface shaping.

The evaporation tube 132 may be fitted over or around the heater 130, and its wire 142 winding where a wire winding is used with the heater 130, thereby creating a fluid heating channel 136 between an inner surface 138 of the evaporation tube 132 and the surface 144 of the heater 130 through which fluid may flow into the evaporator chamber 104. Furthermore, the evaporation tube 132 may be fitted over the heater 130 such that at least a portion of the fluid passing between the inner surface 138 of the evaporation tube 132 and the heater 130 flows along a path defined between the wire 142 windings or along the ridges or grooves. Creating a narrow fluid heating channel 136 between the inner surface 138 of the evaporation tube 132 and the surface 144 of the heater 130 promotes fluid contact with or near the surface 144 of the heater 130. Inclusion of grooves, ridges, or the wire 142 winding further promotes such contact for a longer period of time than would occur if the fluid were directed between a smooth heater 130 and a smooth inner surface 138 of the evaporation tube 132. Such a prolonged exposure to the heater 130, in turn, permits greater heat transfer to the fluid from the heater 130 as the fluid passes by the heater 130.

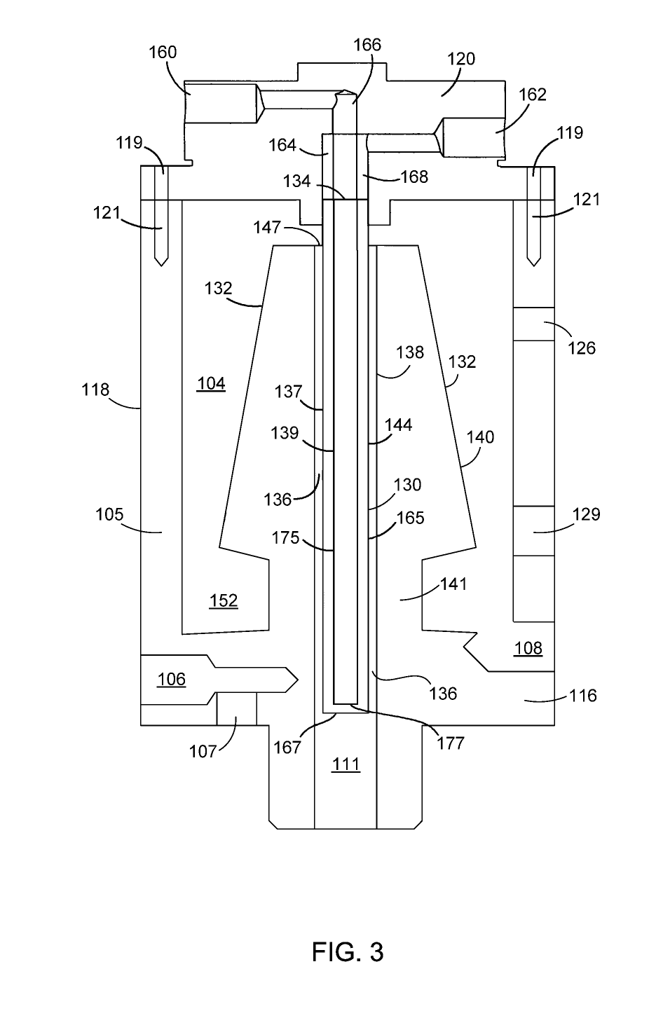

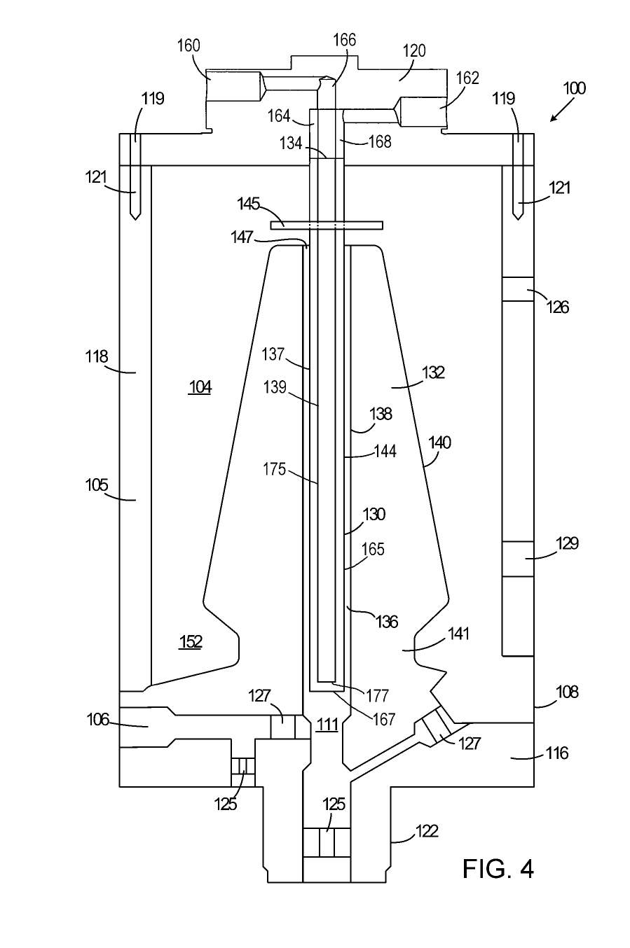

The heated fluid flows out from the evaporator end 147 of the evaporation tube 132 after it passes through the fluid heating channel 136. FIGS. 3 and 4 depict fluid purification apparatuses 100 configured for improved performance in various applications. As illustrated in FIG. 4, a splash guard 145 may be located above the evaporation tube 132 in applications where, for example, fluid pressure in the fluid heating channel 136 is such that the fluid may be propelled against the evaporation chamber cap 120 or where fluid exiting the evaporation tube 132 is desired to be directed by use of such a splash guard 145. Fluid flowing from the evaporation tube 132 may then flow down the outer surface 140 of the evaporation tube 132.

The evaporation tube 132 may be in contact with the divider 116 and may furthermore be attached to the divider 116 or formed with the divider 116, as it is in the embodiment illustrated in FIG. 1. In another embodiment, the evaporation tube 132 is formed separate from the filter base 105 and is attached to the filter base 105 by threads or otherwise as desired. The use of a separately formed evaporation tube 132 may simplify construction of the fluid purification apparatus 100 and may reduce vibration of the evaporation tube.

The evaporation tube 132 may also be shaped variously. In one embodiment the evaporation tube 132 has a conically shaped outer surface 140 that is pinched 141 near where the evaporation tube 132 meets the divider 116, as is illustrated in FIGS. 1, 3, and 4. The pinched portion 141 of the evaporation tube 132 may have a circumference that is less than the circumference of the evaporation tube 132 at the widest part of the conical shape.

The conical shaped evaporation tube 132 outer surface 140 provides a surface that the fluid can flow along in a thin film to enhance evaporation of volatiles. Heat may furthermore be transferred to the evaporation tube 132 from the heater 130 and the pinched portion 141 may reduce heat transfer from the evaporation tube 132 to the divider 116 and the filter base 105. The pinched portion 141 may also enhance the transfer of volatiles from the fluid to the surrounding air by causing the fluid to fall through the air to a fluid reservoir 152 in the evaporation chamber 104.

FIG. 3 illustrates an evaporation chamber 104 having a filter base 105 configured for series oil flow through the filter chamber 102 (not shown) and the evaporator chamber 104. The oil flows into a filter chamber 102 similar to that shown in FIG. 1 through the inlet 106 and filter inlet 107. The oil then flows from the filter chamber 102 into the evaporator chamber 104 through the inner-chamber opening 111. After passing through the fluid heating channel 136, the oil exits the evaporator chamber 104 through the outlet 108.

FIG. 4 illustrates an evaporator chamber 104 having a configurable porting arrangement and including a splash guard 145.

FIG. 5 illustrates an embodiment of an engine 300 incorporating a fluid purification apparatus 100. The engine 300 is an internal combustion engine for an automobile and the fluid purification apparatus 100 is for the engine 300 lubrication system in the embodiment illustrated. It should be noted, however, that the fluid purification apparatus 100 may be used with any engine 300 and to purify any fluid.

The engine 300 includes a battery 302 and a generator 305. The engine 300 includes a lubrication system having a pump 304 that pumps the lubricant through the engine 300 and the fluid purification apparatus 100. A separate pump may be employed to propel the lubricant through the fluid purification apparatus 100 in certain embodiments.

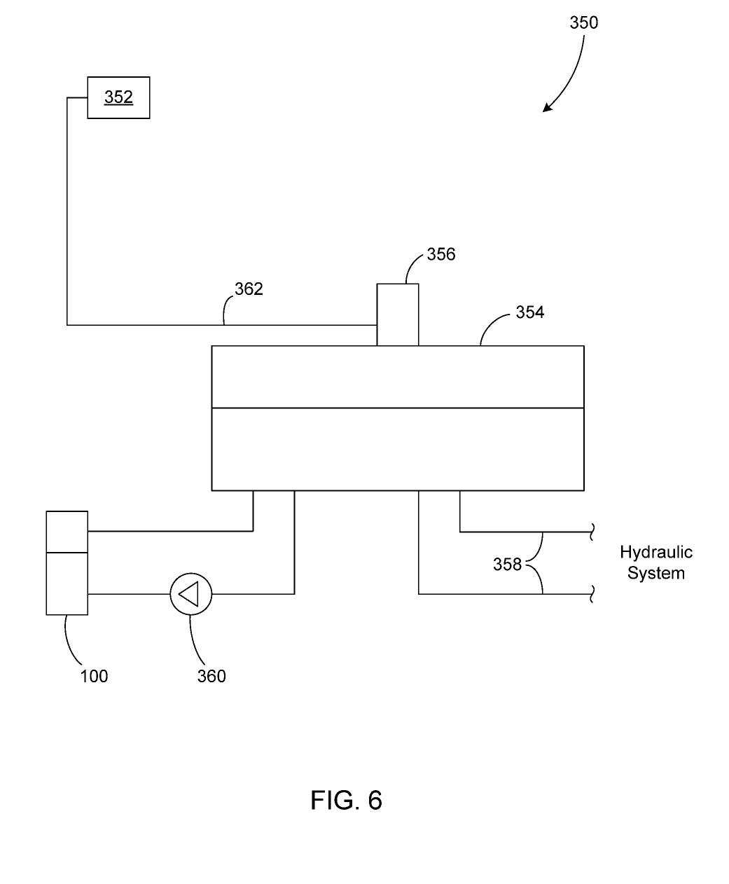

FIG. 6 illustrates a hydraulic system 350 incorporating a fluid purification apparatus 100 and an inlet filter 352. The hydraulic system 350 includes an expansion tank 354 having an inlet breather 356 and one or more tubes 358 through which hydraulic fluid flows as required by the equipment using the hydraulic fluid.

Air moves into and out of the expansion tank 354 as the hydraulic tank 354 level changes due, generally, to demand from the equipment using the hydraulic fluid. The inlet filter 352 is attached to the inlet breather 356 by tubing 362 to clean air moving into the expansion tank 354. Such use of the inlet filter 352 minimizes the introduction of contaminants present in the air drawn into the expansion tank 354.

The fluid purification apparatus 100 operates as described herein to purify the hydraulic fluid. The fluid purification apparatus 100 may be coupled to the tank and a pump 360 may be employed to circulate hydraulic fluid through the fluid purification apparatus 100. Alternately or in addition, one or more fluid purification apparatuses 100 may be positioned in various locations throughout the hydraulic system to remove particulates and volatiles from the hydraulic fluid.

While the present invention has been disclosed with reference to certain embodiments, numerous modifications, alterations, and changes to the described embodiments are possible without departing from the scope of the present invention, as defined in the appended claims. Accordingly, it is intended that the present invention not be limited to the described embodiments, but that it have the full scope defined by the language of the following claims, and equivalents thereof.

What is claimed is:

1. A fluid purification apparatus, comprising:
a particulate filter section;
an evaporator section positioned adjacent the particulate filter section; and
a heat transfer fluid vessel disposed at least partially in the evaporator section.

2. The fluid purification apparatus of claim 1, wherein heat transfer fluid vessel is to contain heated fluid flowing from an engine cooling system.

3. The fluid purification apparatus of claim 2, wherein heat transfer fluid includes at least one of water and glycol.

4. The fluid purification apparatus of claim 1, wherein the heat transfer fluid vessel includes two coaxial tubes, the first coaxial tubes to carry heat transfer fluid to the fluid purification apparatus and the second coaxial tube to carry the heat transfer fluid from the fluid purification apparatus.

5. The fluid purification apparatus of claim 4, wherein the first coaxial tube includes an inner tube having an open end and the second coaxial tube includes an outer tube having a closed end, such that heat transfer fluid will flow through the inner tube to the closed end of the inner tube, impinge against the closed end of the outer tube, and flow through the outer tube.

6. The fluid purification apparatus of claim 1, wherein the heat transfer fluid vessel includes a bayonet tube.

7. The fluid purification fluid purification apparatus of claim 6, further comprising an evaporation tube disposed in the evaporator section, the evaporation tube having a central bore and the bayonet tube being disposed in the central bore of the evaporation tube.

8. The fluid purification apparatus of claim 1, further comprising an evaporation tube disposed in the evaporator section, the evaporation tube having a bore and the heat transfer fluid vessel being disposed at least partially in the bore.

9. The fluid purification apparatus of claim 8, wherein the evaporation tube has a conical shaped outer surface.

10. The fluid purification apparatus of claim 1, further comprising a supply conduit in fluid communication with the heat transfer fluid vessel and a return conduit in fluid communication with the heat transfer fluid vessel.

11. The fluid purification apparatus of claim 10, wherein the supply conduit and the return conduit extend through the fluid purification apparatus for connection to a heat transfer fluid source.

12. The fluid purification apparatus of claim 1, wherein the heat transfer fluid vessel includes a surface and that surface includes a ridge.

13. A method of removing volatiles from an oil, comprising:
heating a chamber using a hot fluid flowing through a channel disposed in the chamber;
causing the oil to flow through the chamber; and
causing a gas to flow through the chamber.

14. The method of removing volatiles from an oil of claim 13, wherein the oil is a hydraulic fluid.

15. The method of removing volatiles from an oil of claim 13, wherein the gas is air.

16. The method of removing volatiles from an oil of claim 13, wherein hot fluid flowing through the channel warms the chamber, thereby causing volatiles in the oil to transition to a gaseous state and the gas flowing through the chamber mixes with the gaseous volatiles, thereby carrying the gaseous volatiles out of the chamber.

17. The fluid purification apparatus of claim 13, further comprising a conduit coupled to the volatile removal inlet and an engine crankcase.

18. The fluid purification apparatus of claim 13, further comprising a conduit coupled to the volatile removal outlet and an air cleaner.

19. An evaporation chamber, comprising:
an enclosure;
an evaporation tube extending at least partially into the enclosure;
a heat transfer fluid inlet passing through the enclosure;
a heat transfer fluid outlet passing through the enclosure;
a heat transfer fluid passage passing from the heat transfer fluid inlet, through the evaporation tube, to the heat transfer fluid outlet;
a volatile containing fluid inlet passing through the enclosure;
a volatile containing fluid outlet passing through the enclosure;
a volatile containing fluid passage passing from the volatile containing fluid inlet to the evaporation tube;
a volatile removal inlet through the enclosure; and
a volatile removal outlet through the enclosure.
